(19) United States
(12) Patent Application Publication
(10) Pub. No.: US 2004/0205242 A1
(43) Pub. Date: Oct. 14, 2004

(54) Querying a peer-to-peer network

(76) Inventors: Zhichen Xu, Sunnyvale, CA (US); Mallik Mahalingam, Sunnyvale, CA (US); Chunqiang Tang, Rochester, NY (US)

Correspondence Address: HEWLETT-PACKARD COMPANY, Intellectual Property Administration, P.O. Box 272400, Fort Collins, CO, 80527-2400, US

(21) Appl. No.: 10/385,667

(22) Filed: Mar. 12, 2003

(51) Int. Cl. G06F 15/16

(52) U.S. Cl. 709/245; 709/201

(57) ABSTRACT

In a peer-to-peer network information is received. A vector is generated from the information. The vector includes at least one element associated with the information. At least some of the vector and an address index for the received information are published to at least one node in the peer-to-peer network.

### FIELD

This invention relates generally to network systems. More particularly, the invention relates to peer-to-peer networks.

### DESCRIPTION OF THE RELATED ART

Generally, the quantity of information that exists on the Internet is beyond the capability of typical centralized search engines to efficiently search. One study estimated that the deep Web may contain 550 billion documents, which is far greater than the 2 billion pages that GOOGLE identified. Moreover, the rate that information continues to grow is typically doubling each year.

Peer-to-peer (P2P) systems have been proposed as a solution to the problems associated with conventional centralized search engines. P2P systems offer advantages such as scalability, fault tolerance, and self-organization. These advantages spur an interest in building a decentralized information retrieval (IR) system based on P2P systems.

However, current P2P searching systems may also have disadvantages and drawbacks. For instance, P2P searching systems are typically unscalable or unable to provide deterministic performance guarantees. More specifically, the current P2P searching systems are substantially based on centralized indexing, query flooding, index flooding or heuristics. As such, centralized indexing systems, such as Napster, suffer from a single point of failure and performance bottleneck at the index server. Flooding-based techniques, such as Gnutella, send a query or index to every node in the P2P system, and thus, consuming large amounts of network bandwidth and CPU cycles. Heuristics-based techniques try to improve performance by directing searches to only a fraction of the population but may fail to retrieve relevant documents.

One class of P2P systems, the distributed hash table (DHT) systems (e.g., content addressable network), provides an improved scalability over the other P2P systems. However, DHT systems are not without disadvantages and drawbacks. Since they offer a relatively simple interface for storing and retrieving information, DHT systems are not suitable for full-text searching.

Moreover, besides the performance inefficiencies, a common problem with typical P2P systems is that they do not incorporate advanced searching and ranking algorithms devised by the IR community. Accordingly, the P2P systems typically rely on simple keyword based searching. As a result, conventional P2P systems typically cannot perform advanced searches, such as searching for a song by whistling a tune or searching for an image by submitting a sample of patches.

### SUMMARY

According to an embodiment, a method of placing information in a peer-to-peer network includes receiving information; generating a vector for the information, the vector including at least one element associated with the information; and publishing at least some of the vector and an address index for the information to at least one node in the peer-to-peer network.

According to an embodiment, a method of querying a peer-to-peer network includes receiving a query including a request for information; converting the query into a vector including at least one element associated with the query; and searching for the requested information among a plurality of nodes in the peer-to-peer network using the vector.

According to an embodiment, an apparatus in a peer-to-peer network includes means for receiving information; means for generating a vector for the information, the vector including at least one element associated with the information; and means for publishing at least some of the vector and an address index for the information to at least one node in the peer-to-peer network.

According to an embodiment, an apparatus in a peer-to-peer network includes means for receiving a query including a request for information; means for converting the query into a vector including at least one element associated with the query; and means for searching for the requested information among a plurality of nodes in the peer-to-peer network using the vector.

According to an embodiment, a system includes a plurality of peers in a peer-to-peer network, and an overlay network implemented by the plurality of peers, wherein the overlay network is configured to be divided into zones, each zone owned by a respective peer of the plurality of peers. The system also includes a plurality of indices, each index of the plurality of indices being based on a term of information. Each index of the plurality of indices is configured to be associated with a respective peer of the plurality of peers. The system also includes a query module stored and executed by each peer of the plurality of peers, wherein the query module is configured to hash at least one element of a vectorized query to a selected point in the overlay network and receive candidate information from a respective index stored at a selected peer that owns the respective zone where the selected point falls.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a logical representation of an embodiment;

FIG. 2 illustrates a logical perspective another embodiment;

FIG. 3 illustrates an exemplary architecture for the peer search node in accordance with yet another embodiment;

FIG. 4 illustrates an exemplary routing table for the peer search node in accordance with yet another embodiment;

FIG. 5 illustrates an exemplary flow diagram for the query module of the peer search module shown in FIG. 3 in accordance to yet another embodiment;

FIG. 6 illustrates an exemplary flow diagram for the routing module of the peer search module shown in FIG. 3 in accordance with yet another embodiment;

FIG. 7 illustrates an exemplary flow diagram for the index module of the peer search module shown in FIG. 3 in accordance with yet another embodiment;

FIG. 8 illustrates an exemplary flow diagram for the query module of the peer search module shown in FIG. 3 in accordance with yet another embodiment;

FIG. 9 illustrates an exemplary flow diagram for publishing information to a peer-to-peer network in accordance with an embodiment;

FIG. 10 illustrates an exemplary flow diagram for publishing information to a peer-to-peer network in accordance with another embodiment; and

FIG. 11 illustrates a computer system where an embodiment may be practiced.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of network systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment, a system for the controlled placement of documents is provided in order to facilitate searching for information (e.g., documents, data, etc.). In particular, a subset of the peers (or nodes) of a peer-to-peer (P2P) network implement a peer search network, an auxiliary overlay network over the P2P network. A logical space formed by the peer search network may be a d-torus, where d is the dimension of the logical space. The logical space is divided into fundamental (or basic) zones where each node of the subset is the peers is an owner. Additional zones are formed over the fundamental zones. The peer search network can also be other DHT-based overlay network such as Chord and Pastry.

Vector space modeling may be used to represent documents and queries as term vectors. For example, a vector space modeling algorithm may be used to generate a term vector having m-heaviest weighted elements. For example, each element (e.g., a term in a document) of the term vector corresponds to the importance of a word or term in a document or query. The weight of an element may be computed using the statistical term frequency * an inverse document frequency. In other words, weight may be based on a frequency of a term in a document and a frequency of the term in other documents. Thus, if a term has a frequency in a document it will be given more weight. However, if that term appears in many other documents, then the weight of that term may be reduced. It will be apparent to one of ordinary skill in the art that vector space modeling may be used to generate vectors for information other than documents. For example, songs, web pages, and other data may be modeled for controlled placement of the information in the network and for searching the network.

In the peer search network, information (e.g., documents, web pages, data, etc.) may be represented by a key pair comprising of a hash point and an address index (e.g., the address index may comprise the information itself, its full term or partial term vector representation produced by algorithms such as VSM, a universal resource locator, a network address, etc.). The key pair may then be routed to the node that is the owner of the zone where the hashed point falls in the overlay network. Indices may then be formed from similar key pairs at respective nodes. Accordingly, similar key pairs are placed in one peer or in nearby neighboring peers.

The hash point may be a hashed term vector. For example, vector space modeling is used to generate a term vector, such as the m-heaviest weighted terms in a document. A hash function is used to map a string (e.g., one of the m-heaviest weighted term) into a point in the overlay network for placement of the term vector and address index of the document. Each of the m-heaviest weighted terms may be hashed to identify m points in the network for placing the term vector and address index of the document. Therefore, the term vector and address index of the document is stored in multiple places in the peer search network.

In order to increase accuracy of search results and to maximize storage utilization, different techniques may be implemented to control replication of a term vector based on popularity of a document. At least two factors are relevant for controlling placement and replication. Firstly, when information pertaining to a document is published to a node, the entire term vector (at least for some embodiments) and address index of the actual document is published. As a result, instead of returning all the documents that match a particular term in a query, a local search using the vector representation can be performed to reduce the number of documents returned to the initiator, thereby reducing network traffic.

Secondly, when selecting the m-heaviest weighted elements of a term vector v of a document F, the information of the document is, in effect, replicated m times. To optimize storage space utilization, the amount of replication of a document is made proportional to the popularity of the document according to an embodiment of the invention.

In this embodiment, the per-document m value (terms used for hashing) is adjusted based on the popularity of the document. For example, a term vector of a document F has a total of n elements. This n-element vector is partitioned into two segments, v1 that consists of elements 1 to m, and v2 that consists of elements m+1 to n. For a term t1 that belong to v1, the entire vector v and the address index (e.g., the location of the document, such as a URL) is published to the node hashed to by h(t1), where h is the hash function that maps a string to a node in the peer search overlay network. However, for a term t2 that belongs to v2, “compressed” information of the document is published. The compressed information may include less information than that which is published for the first segment v1. For example, only the URL or a subsegment of v is published to the node that is hashed to by h(t2). Also, data for the segment v2 may be compressed using conventional compression algorithms.

The partition m of the term vector for document F may initially be arbitrarily selected. However, the partition m may be dynamically adjusted to account for the documents popularity. In one embodiment, each time a document is retrieved and determined to be relevant by a user, a per-document popularity count is incremented. When the popularity count exceeds a certain threshold (could be a series of thresholds), more terms of the document are used to store the document. For example, the first segment v1 is grown to include terms from the second segment v2. Similarly, if the popularity count is very low for a document, the m value can be reduced to reduce the amount of replication for the document. For example, terms from the first segment v1 are reduced and moved to the second segment v2 where the terms are compressed.

Another embodiment includes dynamically adjusting the partition m on which node the information of a document is compressed. For a particular node x, each time “compressed” information is “decompressed” (e.g., the corresponding URL is traversed), a per-term popularity count is incremented. Terms having a popularity count greater than a threshold are not compressed while the remaining terms get compressed. To ensure that the popularity counts can reflect the current situation, terms that have not had hits for a predetermined period of time are compressed.

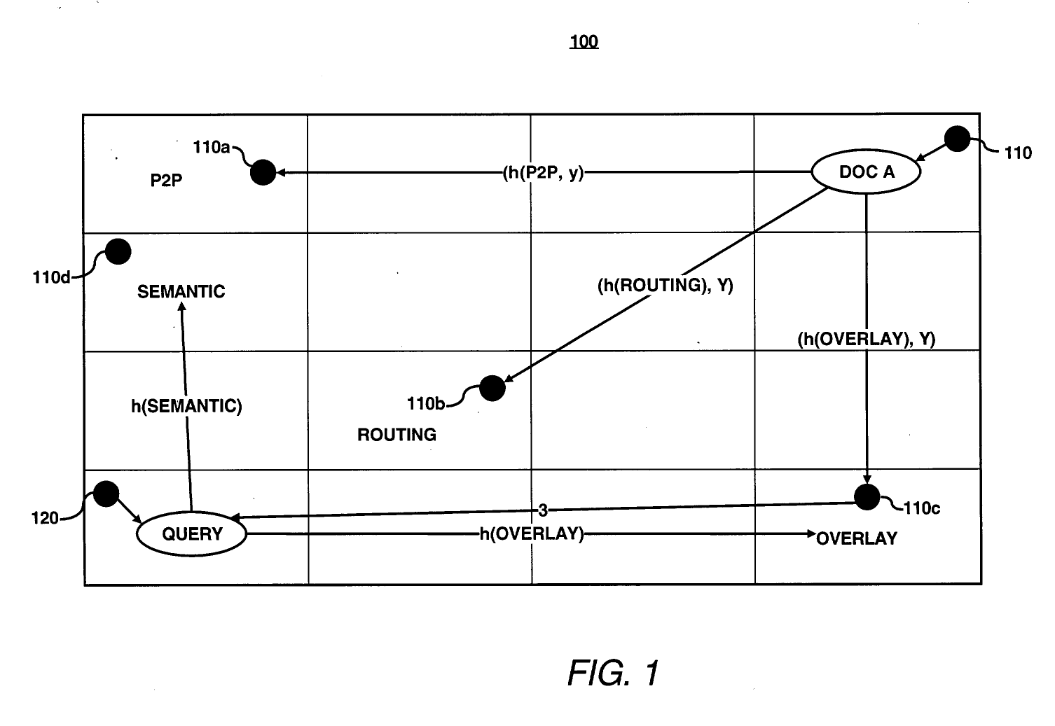

When a query is received, each term of the query is hashed into a point using the same hash function. The query is then routed to nodes whose zones contain the hashed points. Each of nodes may retrieve the best-matching key pairs within the node. Each node may retrieve the information associated with the matching key pairs and rank the retrieved information based on vector-space modeling (VSM) algorithms. Each node may then forward the ranked information to the query initiator. The query initiator may filter or rank the retrieved information (i.e., the candidate information) globally and provide the filtered retrieved information to a user, which may be illustrated with respect to FIG. 1.

FIG. 1 illustrates a logical diagram of an embodiment. As shown in FIG. 1, the overlay network 100 of a peer search network may be represented as a two-dimensional Cartesian space, i.e., a grid. It should be readily apparent to those skilled in the art that other DHT based peer-to-peer networks can be used. Each zone of the overlay network 100 includes a peer that owns the zone. For example, in FIG. 1, the black circles represent the owner nodes for their respective zones. For clarity, the rest of the nodes are not presented.

In an embodiment, an item of information (shown as DOC A in FIG. 1) may be received at a peer search node 110. Peer search node 110 may compute a term vector for the item of information based on the m-heaviest heavily weighted terms of the item of information. In this example, the most heavily weighted terms are “P2P”, “ROUTING”, and “OVERLAY” in DOC A. A hash function is applied to each element of the term vector. An index of the key pairs is created, where each key pair includes the hashed element and an address index of the item of information. A key pair is then published (i.e., stored) to a respective node that owns the zone in the overlay network 100 where the respective hashed element of the key pair falls. The term vector Y of the actual document may be published with the hashed term as the key pair. In FIG. 1, the key pair of (h(P2P), Y) is published to peer 110a; key pair of (h(ROUTING), Y) is published to peer 110b; (h(overlay), Y) is published to peer 110c. Accordingly, similar information may be gathered at one or nearby nodes, thus improving the search for information. A query may be received at peer 120. Continuing with the above example, the query may contain the terms “SEMANTIC” and “OVERLAY”. The hash function is applied to the query to obtain the points defined by h(SEMANTIC) and h(OVERLAY), respectively. Peer 120 may route the query to respective nodes that own the zones (peer 110d and peer 110c, respectively) where h(SEMANTIC) and h(OVERLAY) fall in the overlay network 100.

The peers 110c and 110d may search their respective indices locally for the key pairs that best-match to the query to form a candidate set of information. The search includes a search of the term vectors stored in each node to identify documents that match the query. The peers 110c and 110d may rank or filter the candidate set of information and return the information to peer 120.

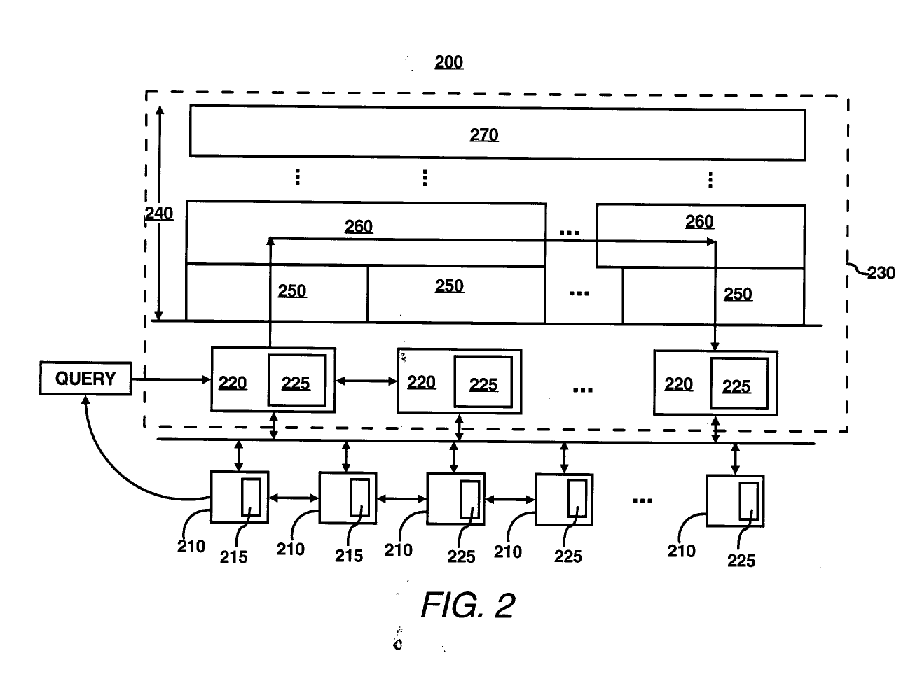

FIG. 2 illustrates an exemplary schematic diagram of an embodiment 200. As shown in FIG. 2, peers (or nodes) 210 may form a peer-to-peer network. Each peer of peers 210 may store and/or produce information (e.g., documents, data, web pages, etc.). The items of information may be stored in a dedicated storage device (e.g., mass storage) 215 accessible by the respective peer. The peers 210 may be computing platforms (e.g., personal digital assistants, laptop computers, workstations, and other similar devices) that have a network interface.

The peers 210 may be configured to exchange information among themselves and with other network nodes over a network (not shown). The network may be configured to provide a communication channel among the peers 210. The network may be implemented as a local area network, wide area network or combination thereof. The network may implement wired protocols such as Ethernet, token ring, etc., wireless protocols such as Cellular Digital Packet Data, Mobitex, IEEE 801.11b, Wireless Application Protocol, Global System for Mobiles, etc., or combination thereof.

A subset of the peers 210 may be selected as peer search nodes 220 to form a peer search network 230. The peer search network 230 may be a mechanism to permit controlled placement of key pairs within the peer search peers 220. In the peer search network 230, an item of information may be represented as indices comprised of key pairs. A key pair (or data pair) of a hashed element of a term vector of the item of information and an address index of the item of information. The peers 210 may be configured to publish the key pairs to respective nodes where the hashed element falls within their zones. Accordingly, the peer search network 230 may then self-organize the key pairs based on the hashed element of the term vector.

When a query is received, a vector representation of the query may be formulated. For example, the hash function that maps strings to points in the overlay network 100 may be applied to each term in the query to form the vectorized query. The vectorized query is then routed in the peer search network 230 to locate the requested information.

In another embodiment, the peer search network 230 may be configured to include an auxiliary overlay network 240 for routing. A logical space formed by the peer search network 230 may be a d-torus, where d is the dimension of the logical space. The logical space is divided into fundamental (or basic) zones 250 where each node of the subset is the peers is an owner. Additional zones 260, 270 are formed over the fundamental zones to provide expressway routing of key pairs and queries.

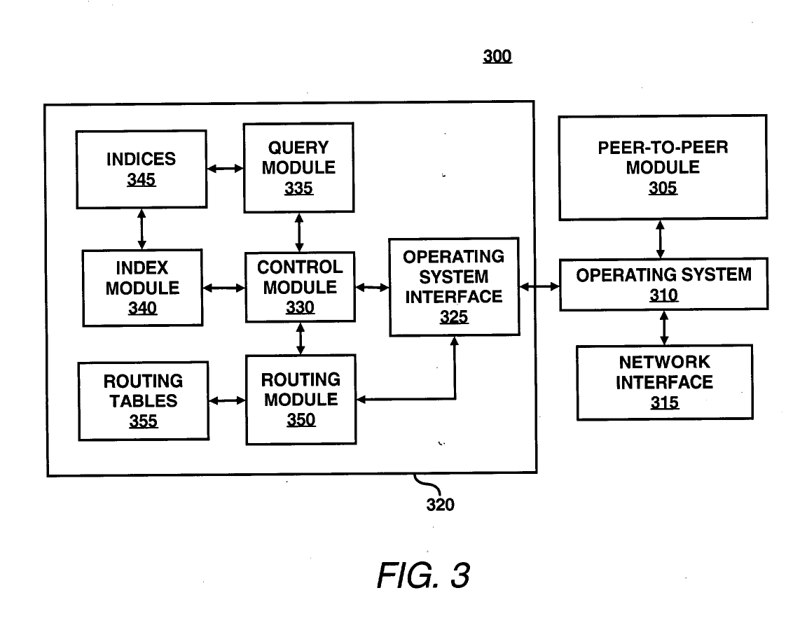

FIG. 3 illustrates an exemplary architecture 300 for the peer search peer 220 shown in FIG. 2 in accordance with an embodiment. It should be readily apparent to those of ordinary skill in the art that the architecture 300 depicted in FIG. 3 represents a generalized schematic illustration and that other components may be added or existing components may be removed or modified. Moreover, the architecture 300 may be implemented using software components, hardware components, or a combination thereof.

As shown in FIG. 3, the architecture 300 may include a peer-to-peer module 305, an operating system 310, a network interface 315, and a peer search module 320. The peer-to-peer module 305 may be configured to provide the capability to a user of a peer to share information with another peer, i.e., each peer may initiate a communication session with another peer. The peer-to-peer module 305 may be a commercial off-the-shelf application program, a customized software application or other similar computer program. Such programs such as KAZAA, NAPSTER, MORPHEUS, or other similar P2P applications may implement the peer-to-peer module 305.

The peer search module 320 may be configured to monitor an interface between the peer-to-peer module 305 and the operating system 315 through an operating system interface 325. The operating system interface 310 may be implemented as an application program interface, a function call or other similar interfacing technique. Although the operating system interface 320 is shown to be incorporated within the peer search module 320, it should be readily apparent to those skilled in the art that the operating system interface 325 may also incorporated elsewhere within the architecture of the peer search module 320.

The operating system 310 may be configured to manage the software applications, data and respective hardware components (e.g., displays, disk drives, etc.) of a peer. The operating system 310 may be implemented by the MICROSOFT WINDOWS family of operating systems, UNIX, HEWLETT-PACKARD HP-UX, LINUX, RIM OS, and other similar operating systems.

The operating system 310 may be further configured to couple with the network interface 315 through a device driver (not shown). The network interface 315 may be configured to provide a communication port for the respective peer over a network. The network interface 315 may be implemented using a network interface card, a wireless interface card or other similar input/output device.

The peer search module 320 may also include a control module 330, a query module 335, an index module 340, at least one index (shown as ‘indices’ in FIG. 3) 345, and a routing module 350. As previously noted, the peer search module 320 may be configured to implement the peer search network for the controlled placement and querying of key pairs in order to facilitate searching for information. The peer search module 320 may be implemented as a software program, a utility, a subroutine, or other similar programming entity. In this respect, the peer search module 320 may be implemented using software languages such as C, C++, JAVA, etc. Alternatively, the peer search module 320 may be implemented as an electronic device utilizing an application specific integrated circuit, discrete components, solid-state components or combination thereof.

The control module 330 of the peer search module 320 may provide a control loop for the functions of the peer search network. For example, if the control module 330 determines that a query message has been received, the control module 330 may forward the query message to the query module 335.

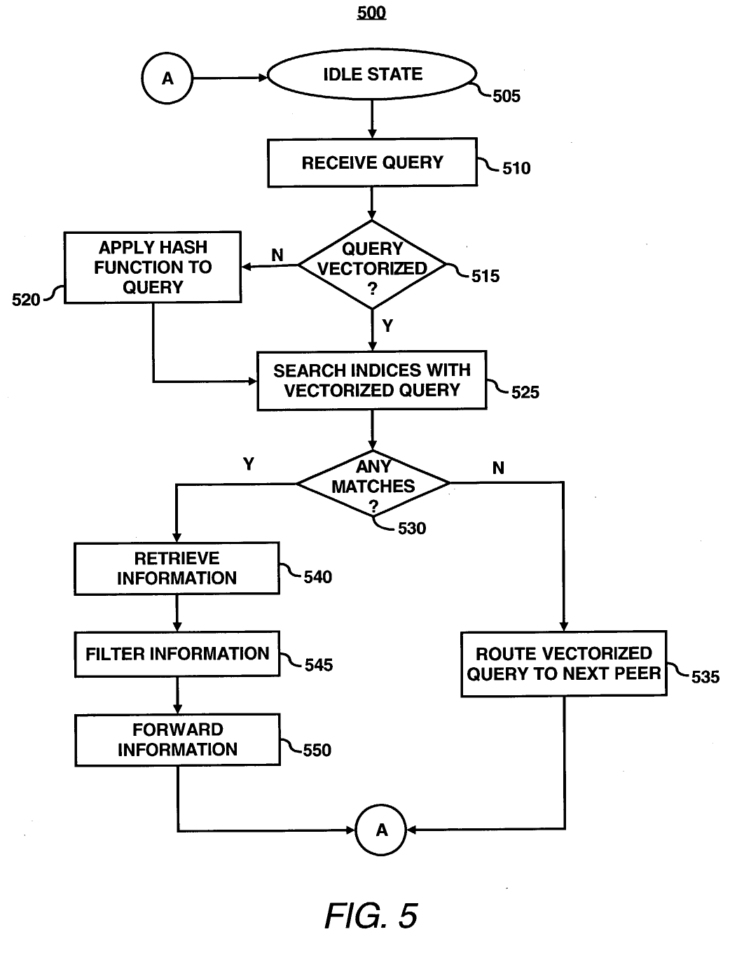

The query module 335 may be configured to provide a mechanism to respond to queries from peers (e.g., peers 110) or other peer search nodes (e.g., 120). As discussed above and in further detail with respect to FIG. 5, the query module 335 may respond to a query for information be determining whether the received query has been vectorized. If the query is not already vectorized, i.e., converted into a vector, each term of the query is hashed by a hash function that maps strings to a point in the overlay network. The query module 335 may be configured to search the indices 355 for any matching key pairs. If there are matching key pairs, the query module 335 may retrieve the indexed information as pointed by the address index in the matching key pair. The query module 335 may then rank the retrieved information by applying VSM techniques to the matching key pairs to form a ranked (or filtered) candidate set of information. The filtered set of information is then forwarded to the initiator of the query. If there are no matching key pairs, the query module 335 may route the vectorized query to another selected peer search node.

The indices module 345 may contain a database of similar key pairs as an index. There may be a plurality of indices associated with each peer search node. In one embodiment, a peer search node may be assigned multiple terms, thus the indices module 345 may contain a respective index for each term. The indices module 345 may be maintained as a linked-list, a look-up table, a hash table, database or other searchable data structure.

The index module 340 may be configured to create and maintain the indices 345. In one embodiment, the index module 340 may receive key pairs published by peers (e.g., peers 100 in FIG. 1). In another embodiment, the index module 340 may actively retrieve, i.e., ‘pull’, information from the peers. The index module 340 may also apply the vector algorithms to the retrieved information and form the key pairs for storage in the indices 345.

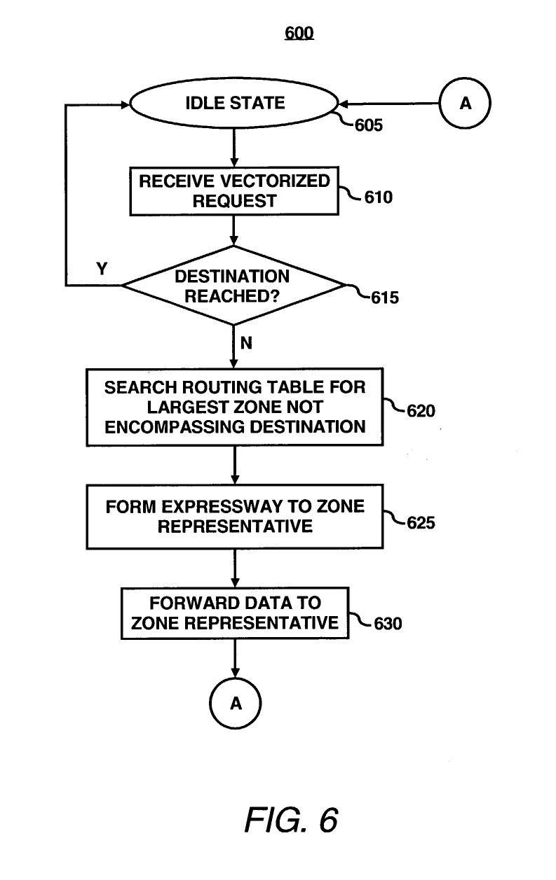

The control module 330 may also be interfaced with the routing module 350. The routing module 350 may be configured to provide expressway routing for vectorized queries and key pairs. Further detail of the operation of the routing module 350 is described with respect to FIG. 6.

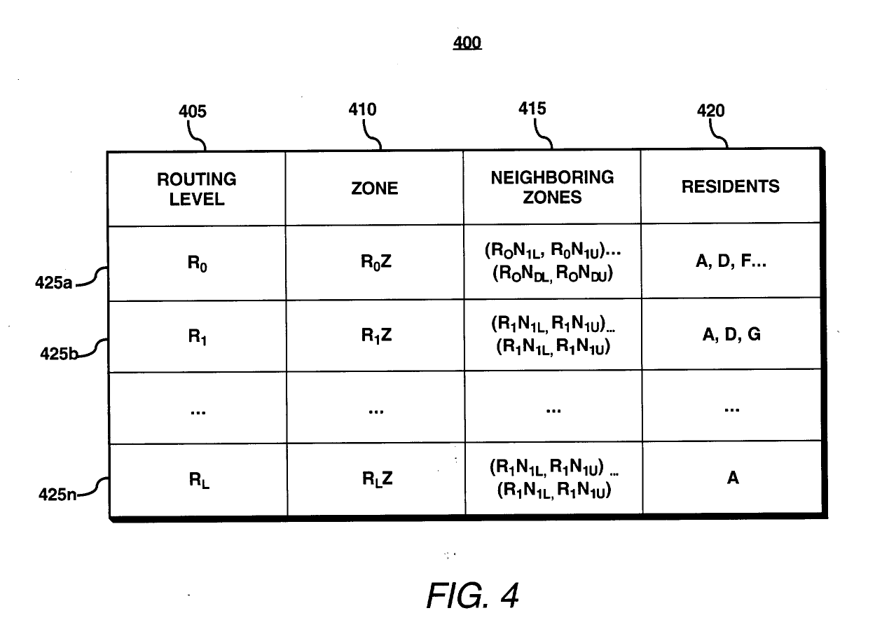

The routing module 350 may access routing table 355 to implement expressway routing. FIG. 4 illustrates an exemplary diagram of the routing table 355 in accordance with an embodiment. It should be readily apparent to those of ordinary skill in the art that the routing table 355 depicted in FIG. 4 represents a generalized illustration and that other fields may be added or existing fields may be removed or modified.

As shown in FIG. 4, the routing table 355 may include a routing level field 405, a zone field 410, a neighboring zones field 415, and a resident field 420. In one embodiment, the values in the routing level field 405, the zone field 410, the neighboring zones 415, and the resident field 420 are associated or linked together in each entry of the entries 425a . . . n.

A value in the routing level field 405 may indicate the span the between zone representatives. The range of values for the level of the zone may range from the current unit of the overlay network (R_{L}) to the entire logical space of the P2P system (R₀). The largest value in the routing level field 405 may indicate the depth of the routing table as well as being the current table entry.

A value in the zone field 410 may indicate which zones the associated peer is aware thereof. Values in the neighboring zones field 415 indicate the identified neighbor zones to the peer. A neighbor zone may be determined by whether a zone shares a common border in the coordinate space; i.e., in a d-dimensional coordinate space, two nodes are neighbors if their coordinate spans overlap along d−1 dimensions and abut along one dimension.

Values in the resident fields 420 may indicate the identities of residents for the neighboring zones stored in the neighboring zones field 415. The values in residents field 420 may be indexed to the values the neighboring zones field 415 to associate the appropriate resident in the proper neighboring zone.

FIG. 5 illustrates an exemplary flow diagram 500 for the query module 335 (shown in FIG. 3) according to an embodiment. It should be readily apparent to those of ordinary skill in the art that this method 500 represents a generalized illustration and that other steps may be added or existing steps may be removed or modified.

As shown in FIG. 5, the query module 335 may be in an idle state, in step 505. The control module 425 may invoke a function call to the query module 335 based on detecting a query from the operating system interface 320.

In step 510, the query module 335 may receive the query. The query may be stored in a temporary memory location for processing. The query may be in a non-vectorized form since the query may originate from a peer (e.g., peer 210) and then forwarded to a peer search peer (e.g., peer search peer 220). A received query may be vectorized if forwarded from another peer search node. Accordingly, in step 515, the query module 335 may be configured to test if the received query is vectorized. If the query is not vectorized, the query module 335 may apply a hash function to each element of the received query, in step 520. Subsequently, the query module 335 proceeds to the processing of step 525.

Otherwise, if the received query is vectorized, the query module 335 may search the indices 340 with the received query as a search term, in step 525. A search of the indices may include a search of the term vectors stored at the peer 220. If the query module 335 determines that there are no matching key pairs in the indices 345, the query module 335 may route the query to the next peer indicated by the vectorized query, in step 535. Subsequently, the query module 335 may return to the idle state of step 505.

Otherwise, if the query module 335 determines there are matching key pairs, the query module 335 may retrieve the information as pointed by the respective address index of the matching key pairs and store the matching information in a temporary storage area, in step 540. The query module 335 may then rank the matching information by applying vector space modeling algorithms to form a ranked set of preliminary information, in step 545. The query module 335 may forward the ranked set of preliminary to the initiator of the query, in step 550. Subsequently, the query module 335 may return to the idle state of step 505.

FIG. 6 illustrates an exemplary flow diagram for a method 600 of the routing module 345 shown in FIG. 3 in accordance with another embodiment. It should be readily apparent to those of ordinary skill in the art that this method 600 represents a generalized illustration and that other steps may be added or existing steps may be removed or modified.

As shown in FIG. 6, the routing module 350 of the peer search module 230 may be configured to be in an idle state in step 605. The routing module 350 may monitor the network interface 315 via the operating system 320 (shown in FIG. 3) for any received requests to route data. The requests may be initiated by a user of a peer or the requests may be forwarded to the receiving peer functioning as an intermediate peer. Alternatively, the requests to route may be received from the query module 330 as described above with respect to FIG. 6.

In step 610, the routing module 350 may received the vectorized request. The routing module 350 may determine a destination address of the peer search node by extracting a hashed element from the vectorized query.

In step 615, the routing module 350 determines whether the request has reached its destination. More particularly, the routing module 350 may check the destination address of the request to determine whether the receiving peer is the destination for the request. If the destination is the receiving peer, the routing module 350 may return to the idle state of step 605.

Otherwise, in step 620, the routing module 350 may be configured to search the routing table 355 for a largest zone not encompassing the destination. It should be noted that the largest zone that does not encompass the destination can always be found, given the way the zones are determined as described above.

In step 625, the routing module 350 may be configured to form a communication channel, i.e., an expressway, to the zone representative of the destination zone at the level of the largest zone. The routing module 350 may forward the requested data to the zone representative in the destination zone in step 630. The zone representative will then forward the data to the destination peer. Subsequently, the routing module 350 may return to the idle state of step 605.

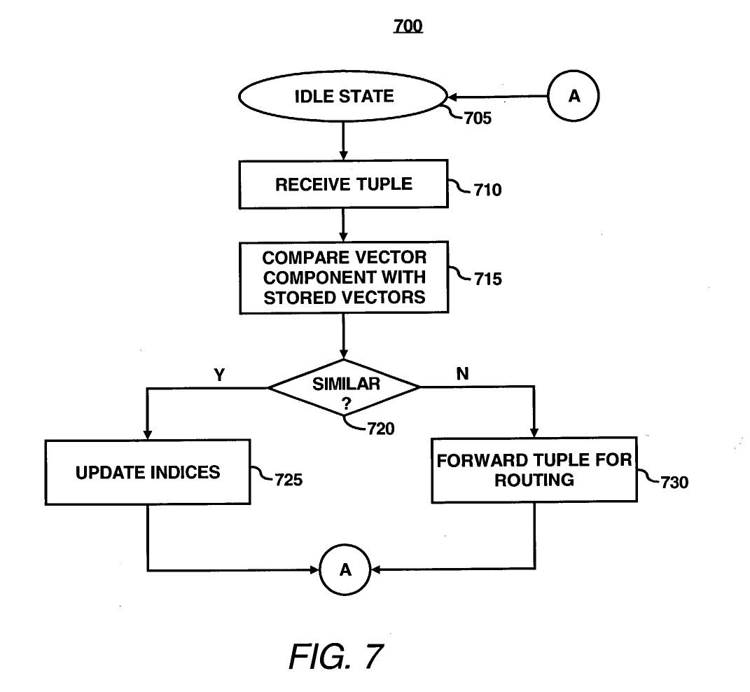

FIG. 7 illustrates an exemplary embodiment of a method 700 of the index module 340 shown in FIG. 3 in accordance with an embodiment. It should be readily apparent to those of ordinary skill in the art that this method 700 represents a generalized illustration and that other steps may be added or existing steps may be removed or modified.

As shown in FIG. 7, the index module 340 may be in an idle state, in step 705. The control module 325 may detect the receipt of a key pair through the network interface 515 through the operating system interface 320. The control module 325 may be configured to forward or invoke the index module 340.

In step 710, the index module 340 may be configured to receive the key pair. The index module 340 may store the key pair in a temporary memory location. In step 715, the vector component of the key pair is extracted.

In step 720, the index module 340 may compare the vector component for similarity to the vectors currently stored in the indices 340. In one embodiment, a cosine between the component vector and a selected vector of the stored vectors is determined. The cosine is then compared to a user-specified threshold. If the cosine exceeds the user-threshold, the two vectors are determined to be dissimilar.

If the key pair is similar to the key pairs stored in the indices, the index module 340 may update the indices with the received key pair, in step 725. Subsequently, the index module 340 may return to the idle state of step 705. Otherwise, the index module 340 may forward the received key pair to the routing module 345 for routing, in step 730. Subsequently, the index module 340 may return to the idle state of step 705.

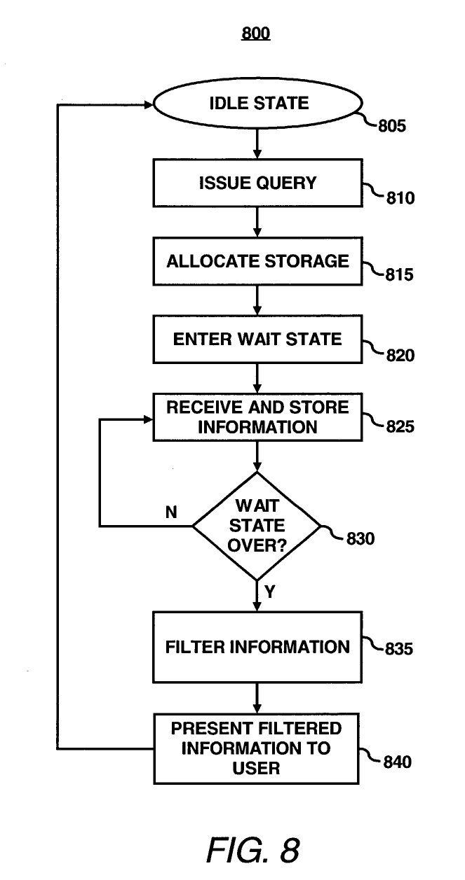

FIG. 8 illustrates an exemplary flow diagram for a method 800 of the query module 335 as a query initiator module in accordance with an embodiment. It should be readily apparent to those of ordinary skill in the art that this method 800 represents a generalized illustration and that other steps may be added or existing steps may be removed or modified.

As shown in FIG. 8, the query module 335 may be in an idle state in step 805. The query module 335 may receive a request for a query through the operating system interface 325. The query module 335 may then form a query as discussed with respect to FIG. 5 and issue the query to the peer search network 230, in step 810.

The query module 335 may also be configured to allocate temporary storage space for the retrieved information, in step 815. The query module 335 may enter a wait state to wait for the information to be gathered in step 820. The wait state may be implemented using a timer or use event-driven programming.

During the wait state, in step 825, information from the query may be stored in the allocated temporary storage location. The query module 335 may be configured to determine whether the wait state has finished, in step 830. If the wait state has not completed, the query module 335 returns to step 825.

Otherwise, if the wait state has completed, the query module 335 may be configured to apply vector-space modeling techniques to filter the received items of information to rank the most relevant, in step 835. In step 840, the query module 335 may then provide the filtered items of information to the user. Subsequently, the query module 335 may return to the idle sate of step 805.

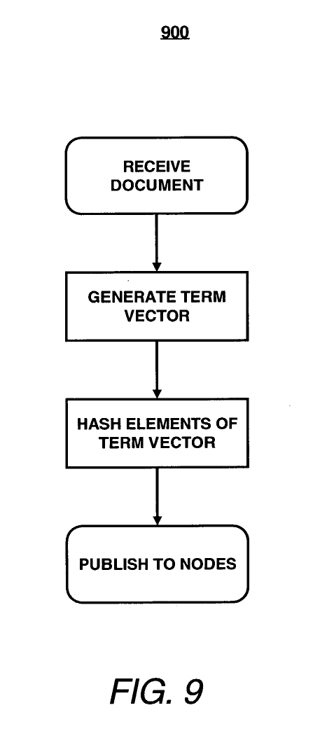

FIG. 9 illustrates a method 900 for publishing vectors in the peer-to-peer network 200 of FIG. 1, according to an embodiment of the invention. In step 910 a peer search node 220 receives a document to be published. In step 920, a term vector is generated using vector space modeling. For example, the term vector includes the m-heaviest weighted elements of the document. In step 930, each of the m-heaviest weighted elements is hashed to identify points in an overlay network (e.g., a CAN network) for the peer-to-peer network 200. In step 940, an address index (e.g., term vector, a URL, etc.) is published to multiple nodes in the peer-to-peer network 200 associated with the identified points in the overlay network. Thus the term vector is stored at multiple nodes in the peer-to-peer network 200.

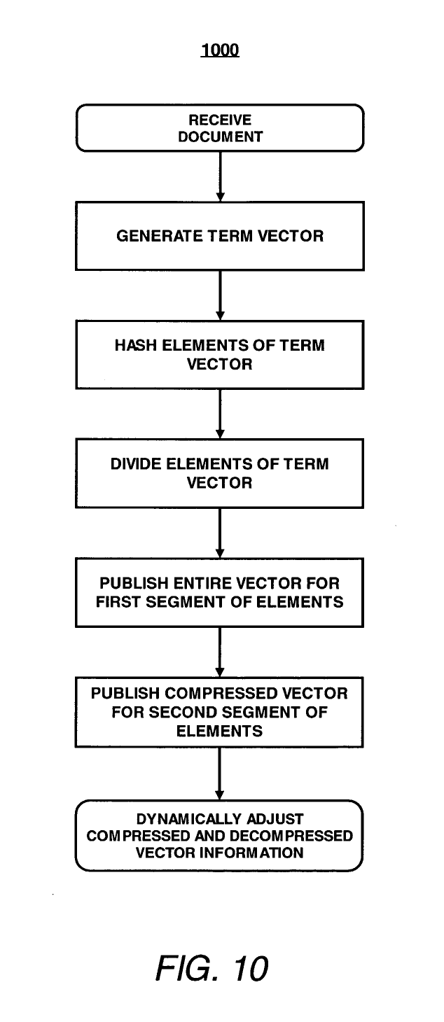

To optimize storage space utilization, the amount of replication of a document is made proportional to the popularity of the document according to an embodiment of the invention. FIG. 10 illustrates a method 1000 for publishing vector information in the peer-to-peer network 200 of FIG. 1, according to an embodiment of the invention. In step 1010, a peer search node 220 receives a document to be published. In step 1020, a term vector is generated using vector space modeling. For example, the term vector includes the m-heaviest weighted elements of the document. In step 1030, each of the m-heaviest weighted elements is hashed to identify points in an overlay network (e.g., a CAN network) for the peer-to-peer network 200.

In step 1040, the m-heaviest weighted elements are divided into two segments (e.g., 1 to n elements for the first segment and n+1 to m elements for the second segment). If the most popular terms (elements) are provided in the first segment based on the vector space modeling algorithm used to generate the term vector, then the entire term vector are published for each of the elements 1 to n (step 1050). “Compressed” vector information is published with an address index for the second segment of elements (step 1060). The compressed information may include less information than that which is published for the first segment v1. For example, only the URL or a subsegment of the second segment is published. Also, data may be compressed using conventional compression algorithms.

In step 1070, the compressed term vectors and uncompressed term vectors are dynamically adjusted based on the popularity of the term associated with the term vector. For example, the partition n of the term vector may initially be arbitrarily selected. The term n+1 is initially hashed to identify a node for publishing the compressed term vector (step 1030). The compressed term vector is stored at the node. If the term n+1 receives a predetermined number of hits (i.e., the popularity count of the term n+1 exceeds a threshold), the uncompressed term vector may be stored at the node instead of the compressed term vector. A hit may include a query having the n+1 term. Also, to ensure that the popularity counts can reflect the current situation, terms that have not had hits for a predetermined period of time are compressed.

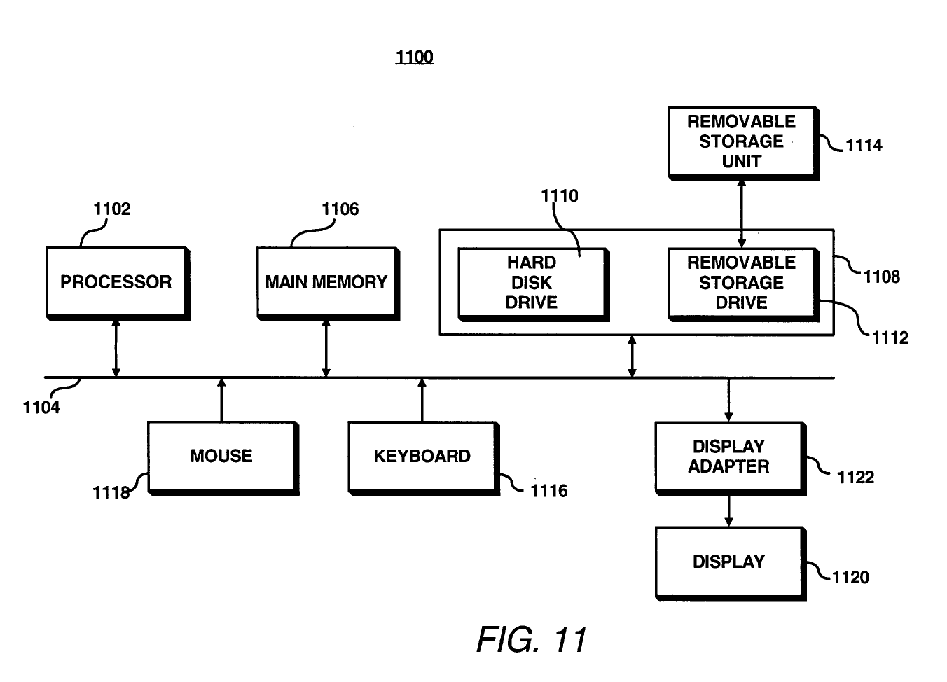

FIG. 11 illustrates an exemplary block diagram of a computer system 1100 where an embodiment may be practiced. The functions of the range query module may be implemented in program code and executed by the computer system 1100. The expressway routing module may be implemented in computer languages such as PASCAL, C, C++, JAVA, etc.

As shown in FIG. 11, the computer system 1100 includes one or more processors, such as processor 1102, that provide an execution platform for embodiments of the expressway routing module. Commands and data from the processor 1102 are communicated over a communication bus 1104. The computer system 1100 also includes a main memory 1106, such as a Random Access Memory (RAM), where the software for the range query module may be executed during runtime, and a secondary memory 1108. The secondary memory 1108 includes, for example, a hard disk drive 1110 and/or a removable storage drive 1112, representing a floppy diskette drive, a magnetic tape drive, a compact disk drive, etc., where a copy of a computer program embodiment for the range query module may be stored. The removable storage drive 1112 reads from and/or writes to a removable storage unit 1114 in a well-known manner. A user interfaces with the expressway routing module with a keyboard 1116, a mouse 1118, and a display 1120. The display adaptor 1122 interfaces with the communication bus 1104 and the display 1120 and receives display data from the processor 1102 and converts the display data into display commands for the display 1120.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of placing information in a peer-to-peer network, said method comprising:
receiving information;
generating a vector for the information, the vector including at least one element associated with the information; and
publishing at least some of the vector and an address index for the information to at least one node in the peer-to-peer network.

2. The method of claim 1, wherein the peer-to-peer network comprises an overlay network and the step of publishing further comprises:
hashing the at least one element using a hash function to identify a point in the overlay network; and
publishing the address index and the at least some of the vector to the identified point.

3. The method of claim 2, wherein the at least one element of the vector comprises multiple elements, and the method further comprises dividing the multiple elements into a first group and a second group.

4. The method of claim 3, wherein the step of publishing comprises publishing the address index and the entire vector for the first group and publishing the address index and a compressed vector for the second group.

5. The method of claim 4, wherein the compressed vector comprises one of the vector compressed using a compression algorithm and a portion of the vector.

6. The method of claim 3, wherein the step of dividing the multiple elements comprises dynamically dividing the multiple elements based on the popularity of the received information.

7. The method of claim 6, wherein the step of dynamically dividing the multiple elements comprises:
determining a number of hits for an element of the multiple elements;
determining whether the number of hits exceeds a threshold;
assigning the element to the first group if the number of hits exceeds the threshold; and
assigning the element to the second group if the number of hits is less than the threshold.

8. The method of claim 7, wherein the step of dynamically dividing the multiple elements comprises:
determining whether the element of the multiple elements has had a hit within a period of time;
assigning the element to the first group if the element had a hit in the period of time; and
assigning the element to the second group if the element did not have a hit in the period of time.

9. The method of claim 1, wherein the step of generating a vector comprises generating the vector using a vector space modeling algorithm.

10. A method of querying a peer-to-peer network, the method comprising:
receiving a query including a request for information;
converting the query into a vector including at least one element associated with the query; and
searching for the requested information among a plurality of nodes in the peer-to-peer network using the vector.

11. The method of claim 10, wherein the step of searching for the requested information comprises:
receiving said query at a node of the plurality of nodes;
comparing the at least one element of the vector with a respective index stored on the node; and
transmitting candidate information from the node based on said candidate information matching said at least one element of the vector.

12. The method of claim 11, further comprising:
retrieving said candidate information from said respective index based on said at least one element of said vector matching an item of said respective index; and
filtering said candidate information based on vector space modeling.

13. The method of claim 12, further comprising:
receiving a set of candidate information matching said at least one element from a subset of nodes of said plurality of nodes, said set of candidate information being included in indices of the subset of nodes; and
filtering said set of candidate information based on said vector.

14. The method according to claim 10, wherein said conversion of said query for said requested information is based on vector-spaced modeling.

15. The method according to claim 10, wherein searching for the requested information comprises:
hashing the at least one element of said query with a hash function; and
routing said hashed at least one element to a selected point in an overlay network of the peer-to-peer network.

16. An apparatus in a peer-to-peer network comprising:
means for receiving information;
means for generating a vector for the information, the vector including at least one element associated with the information; and
means for publishing at least some of the vector and an address index for the information to at least one node in the peer-to-peer network.

17. The apparatus of claim 16, wherein the peer-to-peer network comprises an overlay network and the apparatus comprises:
hashing means for hashing the at least one element using a hash function to identify a point in the overlay network for publishing the at least some of the vector to the at least one node associated with the identified point in the overlay network.

18. The apparatus of claim 16, wherein the at least one element of the vector comprises multiple elements, the apparatus further comprising:
dynamically dividing means for assigning each of the multiple elements into one of a first group and a second group based on a popularity of the received information.

19. The apparatus of claim 18, wherein the publishing means comprises means for publishing the entire vector for the first group of elements and means for publishing a compressed vector for the second group of elements.

20. An apparatus in a peer-to-peer network comprising:
means for receiving a query including a request for information;
means for converting the query into a vector including at least one element associated with the query; and
means for searching for the requested information among a plurality of nodes in the peer-to-peer network using the vector.

21. The apparatus of claim 20, further comprising:
means for receiving said query at a node of the plurality of nodes;
means for comparing the at least one element of the vector with a respective index stored on the node; and
means for transmitting candidate information from the node based on said candidate information matching said at least one element of the vector.

22. The apparatus of claim 21, further comprising:
means for retrieving said candidate information from said respective index based on said at least one element of said vector matching an item of said respective index; and
means for filtering said candidate information based on vector space modeling.

23. A system comprising:
a plurality of peers in a peer-to-peer network;
an overlay network implemented by said plurality of peers, wherein said overlay network is configured to be divided into zones, each zone owned by a respective peer of said plurality of peers;
a plurality of indices, each index of said plurality of indices based on a term of information, wherein each index of said plurality of indices is configured to be associated with a respective peer of said plurality of peers; and
a query module stored and executed by each peer of said plurality of peers, wherein said query module is configured to hash at least one element of a vectorized query to a selected point in said overlay network and receive candidate information from a respective index stored at a selected peer that owns the respective zone where said selected point falls.

24. The system according to claim 23, wherein said query module is further configured to receive a set of candidate information from a subset of nodes of said plurality of peers, said subset of nodes having indices matching said at least one element of said vectorized query and to filter said set of candidate information based on said vectorized query.

25. The system according to claim 23, wherein said hash function is configured to map strings to a respective point in said overlay network.

26. The system according to claim 23, further comprising an index module stored and executed by each peer of said plurality of peers, wherein said index module is configured to receive an item of information and convert said item of information into a term vector based on an ordering of an occurrence of weighted terms in said item of information.

27. The system according to claim 26, wherein said index module is further configured to apply a hash function to said term vector to create a hashed point.

28. The system according to claim 27, wherein said index module is further configured to create a key pair comprised of said hashed point and an address index.

29. The system according to claim 28, wherein said address index comprises of one of said item of information and a pointer to said item of information.

30. The system according to claim 28, further comprising a routing module stored and executed by each peer of said plurality of peers, wherein said routing module configured to route said key pair within said overlay network based on said hashed point.
